(19) United States
(12) Patent Application Publication
(10) Pub. No.: US 2024/0059531 A1
(43) Pub. Date: Feb. 22, 2024

(54) HANGING FITTING

(71) Applicant: KITO CORPORATION, Yamanashi (JP)

(72) Inventor: Rika SUZUKI, Yamanashi (JP)

(73) Assignee: KITO CORPORATION, Yamanashi (JP)

(21) Appl. No.: 18/265,976

(22) PCT Filed: Dec. 2, 2021
(86) PCT No.: PCT/JP2021/044249

§ 371 Date: Jun. 8, 2023

(30) Foreign Application Priority Data
Dec. 15, 2020 (JP) 2020-207775

(51) Int. Cl. B66C 1/66

(52) U.S. Cl. CPC B66C 1/66

(57) ABSTRACT

A hanging fitting including a link and a rotary fitting, the rotary fitting including an anchor fitting, and a rotary coupling member mounted on the anchor fitting in a state of being rotatable, the rotary coupling member beings provided with a main body part, the main body part being integrally formed with: a base part; a pair of raised parts; and a beam part which surrounds, together with the pair of raised parts, a coupling hole to which the link is pivotally coupled, the pair of raised parts being provided with link receiving parts each provided at a position further away from the anchor fitting in an axial direction of a rotation axis than the base part and provided at a position where the link comes into contact therewith in a state where a tip of the link has a predetermined gap with respect to a cargo.

### TECHNICAL FIELD

The present invention relates to a hanging fitting.

### BACKGROUND ART

There is something called a lifting point among hanging fittings for lifting a cargo. This hanging fitting includes an annular link and a rotary fitting making a coupling portion of the link rotatable, and the rotary fitting is provided with a male threaded portion. On the other hand, there is one of cargoes which is provided with a female threaded portion such as a building component, a metal mold, or the like, and the male threaded portion is screwed and fixed into the female threaded portion of the cargo and a hook or the like is hung on a link member. This makes it possible to lift and move the cargo.

Incidentally, the link is mounted on the rotary fitting via a coupling hole having an inside diameter slightly larger than the wire diameter of the link. Therefore, the link freely moves and turns with respect to the rotary fitting. Thus, the link turns when vibrating or the like, and thereby the link sometimes collides with the cargo to damage the cargo.

Some configurations of preventing the collision of the link with the cargo are those disclosed in Patent Literature 1 and Patent Literature 2. Patent Literature 1 discloses a clamping mechanism which clamps the link. In this clamping mechanism, a pin member is stored in an insertion hole inserted into a coupling hole, and the pin member is pressed by a spring to keep the posture of the link. Besides, Patent Literature 2 discloses a configuration in which a receiving fitting for receiving the link is mounted to a fixing fitting.

### CITATION LIST

### Patent Literature

{PTL 1} DE 102016103050A1
{PTL 2} DE 202015100857U1

### SUMMARY OF INVENTION

### Technical Problem

Incidentally, in the configuration disclosed in Patent Literature 1, it is necessary to provide the clamping mechanism in order to prevent the link from colliding with the cargo. Therefore, the movement of the link is restricted at all time, the configuration of the hanging fitting becomes complicated, the number of parts accordingly increases, and the insertion holes need to be formed, resulting in an increase in product cost.

Further, also in the configuration disclosed in Patent Literature 2, it is necessary to mount the receiving fitting on the rotary fitting. Therefore, the number of parts increases due to the receiving fitting, and the man-hours for mounting the receiving fitting increases, resulting in an increase in product cost.

The present invention has been made in consideration of the above circumstances and its object is to provide a hanging fitting capable of preventing collision of a link with a cargo without restricting the movement of the link more than necessary and capable of preventing increases in number of parts and man-hours when manufacturing.

### Solution to Problem

To solve the above problem, a first viewpoint of the present invention provides a hanging fitting to be mounted on a cargo and including a link and a rotary fitting coupled with the link, the rotary fitting including an anchor fitting to be fixed to the cargo, and a rotary coupling member mounted on the anchor fitting in a state of being rotatable around a rotation axis and being prevented from slipping out, the rotary coupling member beings provided with a main body part, the main body part being integrally formed with: a base part around the rotation axis; a pair of raised parts spaced apart in a circumferential direction of the base part; and a beam part which continues to the raised parts and surrounds, together with the pair of raised parts, a coupling hole to which the link is pivotally coupled, the pair of raised parts being provided with link receiving parts each provided at a position further away from the anchor fitting in an axial direction of the rotation axis than the base part and provided at a position where the link comes into contact therewith in a state where a tip of the link has a predetermined gap with respect to the cargo.

Further, in another aspect of the present invention, it is preferable in the above invention that: slope parts are provided continuing to the link receiving parts on sides, of the pair of raised parts, away from the anchor fitting in the axial direction; and the slope parts have inclined surfaces inclined with respect to the axial direction and are across the base part and the beam part.

Further, in another aspect of the present invention, it is preferable in the above invention that the coupling hole is provided to have a size of 1.1 to 1.5 times a diameter of a cross section of the link.

Further, in another aspect of the present invention, it is preferable in the above invention that the link receiving part is provided in a concave curved surface shape.

### Advantageous Effects of Invention

According to the present invention, it is possible to provide a hanging fitting capable of preventing collision of a link with a cargo without restricting the movement of the link more than necessary and capable of preventing increases in number of parts and man-hours when manufacturing.

### BRIEF DESCRIPTION OF DRAWINGS

FIG. 1 is a perspective view illustrating a configuration of a hanging fitting according to an embodiment of the present invention.

FIG. 2 is a side view illustrating the hanging fitting illustrated in FIG. 1.

FIG. 3 is an exploded perspective view illustrating the configuration of the hanging fitting illustrated in FIG. 1.

FIG. 4 is a side view illustrating a configuration of a hanging fitting having no slope part as a comparison object.

FIG. 5 is a perspective view illustrating a state where a link is in contact with a link receiving part in the hanging fitting illustrated in FIG. 1.

FIG. 6 is a cross-sectional view illustrating a state where the hanging fitting is cut along a plane (XZ-plane) passing through a contact portion between the link receiving part and the link in the state illustrated in FIG. 5.

FIG. 7 is a side view illustrating the state where the link is in contact with the link receiving part in the hanging fitting illustrated in FIG. 1.

FIG. 8 is a perspective view illustrating a state where the link is inclined from the state illustrated in FIG. 5 to come into contact with the slope part.

FIG. 9 is a view illustrating a dimension L1 from a lower end portion of a fitting coupling part of an anchor fitting to an upper end portion of a coupling hole and an inclination angle θ1 of the link in the hanging fitting illustrated in FIG. 1.

FIG. 10 is a view illustrating a dimension in a longitudinal direction of the link and a width dimension L3 of an inner hole of the link in the hanging fitting illustrated in FIG. 1.

FIG. 11 is a view illustrating a dimension L4 between facing outer peripheral parts 32b in the hanging fitting illustrated in FIG. 1.

### DESCRIPTION OF EMBODIMENTS

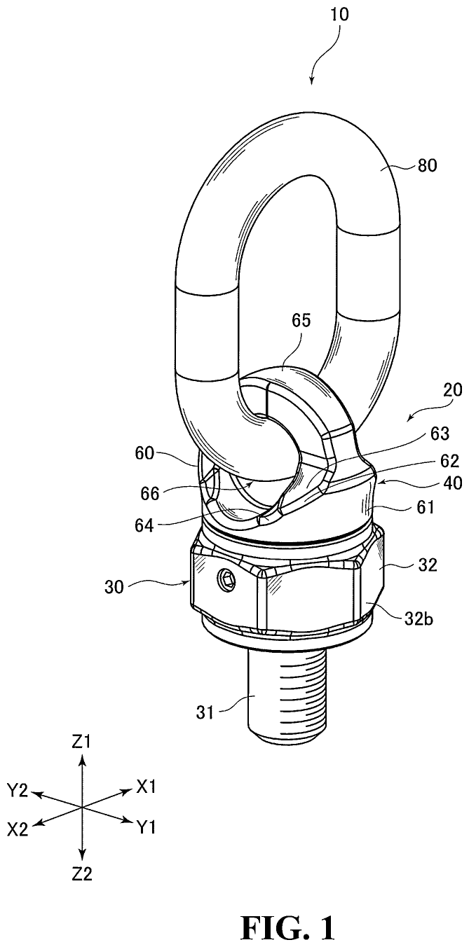

Hereinafter, a hanging fitting 10 according to an embodiment of the present invention will be explained with reference to the drawings. Note that in this embodiment, an extending direction of a coupling hole 66 is regarded as an X-direction, and an upper right side in FIG. 1 is regarded as an X1 side and a lower left side in FIG. 1 opposite thereto is regarded as an X2 side. Further, in FIG. 1, a direction in which both ends of an almost U-shaped beam part 65 are linked is regarded as a Y-direction, and a lower right side in FIG. 1 is regarded as a Y1 side and an upper left side in FIG. 1 opposite thereto is regarded as a Y2 side. Further, an axial direction of a male threaded part 31 is regarded as a Z-direction, and a main body part 60 side when viewed from the male threaded part 31 is regarded as a Z1 side (upper side) and the male threaded part 31 side when viewed from the main body part 60 opposite thereto is regarded as a Z2 side (lower side).

### <Regarding a Configuration of the Hanging Fitting>

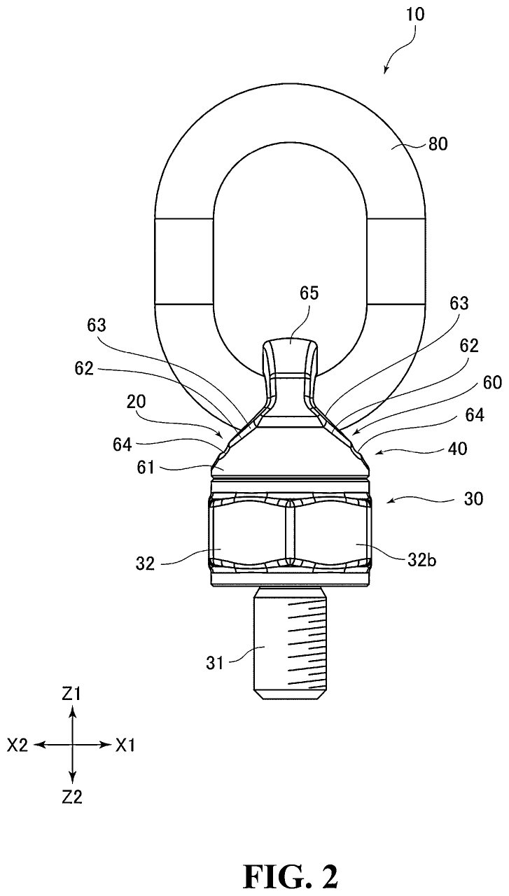

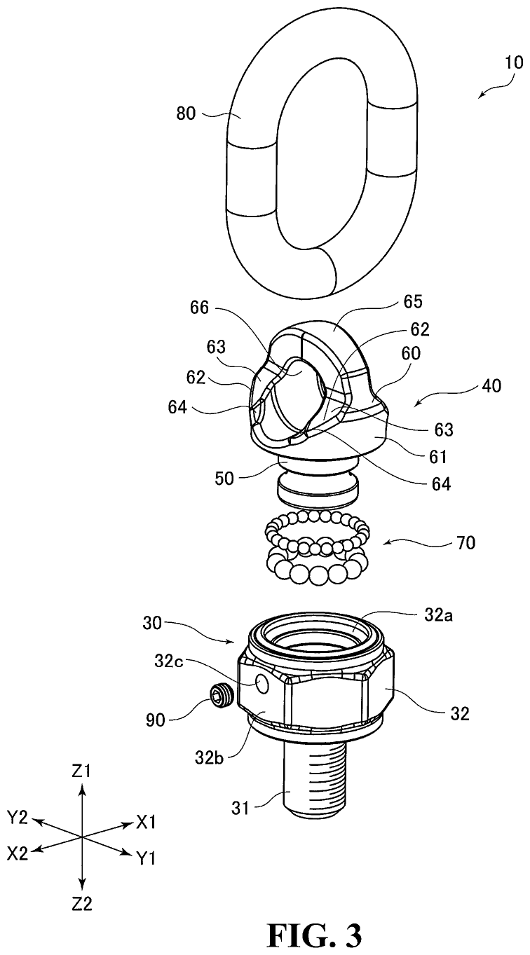

FIG. 1 is a perspective view illustrating a configuration of the hanging fitting 10. FIG. 2 is a side view illustrating the configuration of the hanging fitting 10. FIG. 3 is an exploded perspective view illustrating a configuration of a rotary fitting 20. As illustrated in FIG. 1 to FIG. 3, the hanging fitting 10 has the rotary fitting 20 and a link 80. The rotary fitting 20 of them has an anchor fitting 30, a rotary coupling member 40 and a bearing 70.

The anchor fitting 30 is a portion to be mounted on a not-illustrated cargo, and the anchor fitting 30 in this embodiment is provided in a shape of an almost hexagon bolt having a recess formed at the head portion. The anchor fitting 30 has a shaft portion having the male threaded part 31, and a fitting coupling part 32 at a portion corresponding to the head portion of the hexagon bolt. The male threaded part 31 is a shaft-shaped portion formed with threads, and the male threaded part 31 is screwed into a female thread provided in a mounting hole of the cargo. This fixes the anchor fitting 30 to the cargo.

Besides, the fitting coupling part 32 is a portion coupled with the rotary coupling member 40. As illustrated in FIG. 3, the fitting coupling part 32 is provided with a coupling recessed part 32a in a recessed shape, and a rotary shaft part 50 of the rotary coupling member 40 enters the coupling recessed part 32a. Note that an outer peripheral part 32b of the fitting coupling part 32 is provided in a shape (for example, hexagonal prismatic shape) fittable with a tool such as a wrench, and fitting an action portion of the tool with the outer peripheral part 32b improves the workability when screwing and fastening the male threaded part 31 into the female threaded portion of the cargo.

Further, the fitting coupling part 32 is provided with an input hole 32c (see FIG. 3). Through the input hole 32c, a plurality of bearing balls constituting the bearing 70 are input. Further, the input hole 32c is a threaded hole, and a hexagon socket head screw 90 for sealing is screwed into the input hole 32c. This brings the rotary coupling member 40 into a lock state of being non-rotatable with respect to the anchor fitting 30.

As illustrated in FIG. 1 to FIG. 3, the rotary coupling member 40 is provided with the rotary shaft part 50 and the main body part 60. The rotary shaft part 50 is a shaft-shaped portion to be inserted into the coupling recessed part 32a of the anchor fitting 30. Between the rotary shaft part 50 and the coupling recessed part 32a, the plurality of bearing balls constituting the bearing 70 are arranged, thereby making the rotary coupling member 40 rotatable with respect to the anchor fitting 30.

Further, the main body part 60 is a portion located on a side further away from the anchor fitting 30 than the rotary shaft part 50 in the axial direction (Z-direction) of the hanging fitting 10. The main body part 60 has a base part 61, a raised part 62, and the beam part 65. The base part 61 is a portion, of the rotary coupling member 40, located on the anchor fitting 30 side and a portion having a circular shape in plan view.

The raised part 62 is a portion raised upward (Z1 side) from the base part 61. Two raised parts 62 are provided, and the two raised parts 62 are provided at an interval of 180 degrees in a circumferential direction of the base part 61. Besides, the beam part 65 is an arched portion arranged across the two raised parts 62. By arranging the beam part 65 across the two raised parts 62, an annular portion is formed on the upper surface side of the main body part 60. Further, the beam part 65 and the two raised parts 62 form the annular portion, whereby the main body part 60 is provided with the coupling hole 66 where a portion of the link 80 is located.

The raised part 62 is provided with a slope part 63 and a link receiving part 64. The slope part 63 is a portion having an inclined surface inclined with respect to the axial direction (Z-direction) of the hanging fitting 10, and the link receiving part 64 exists on the lower side (Z2 side) thereof. In this embodiment, the shape of the rotary coupling member 40 in plan view is symmetrical in the X-direction and the Y-direction, so that a total of four slope parts 63 exist.

Further, the slope part 63 is provided so to be wider in width (dimension in the X-direction) as it goes to the lower side (Z2 side). However, as illustrated in FIG. 1, in this embodiment, the upper end of the slope part 63 is provided at a position higher than a middle position in the height direction (Z-direction) of the coupling hole 66. This makes it possible to take a large width of the slope part 63 on the lower side (Z2 side) of the slope part 63.

Due to the existence of the slope part 63, a portion of a corner facing the coupling hole 66 collides with the inner peripheral side of the link 80, thereby making it possible to prevent the inner peripheral side of the link 80 from being damaged to form a recess. It is also possible to take a large movable range of the link 80 even if the link 80 moves in a center axis direction of the coupling hole 66.

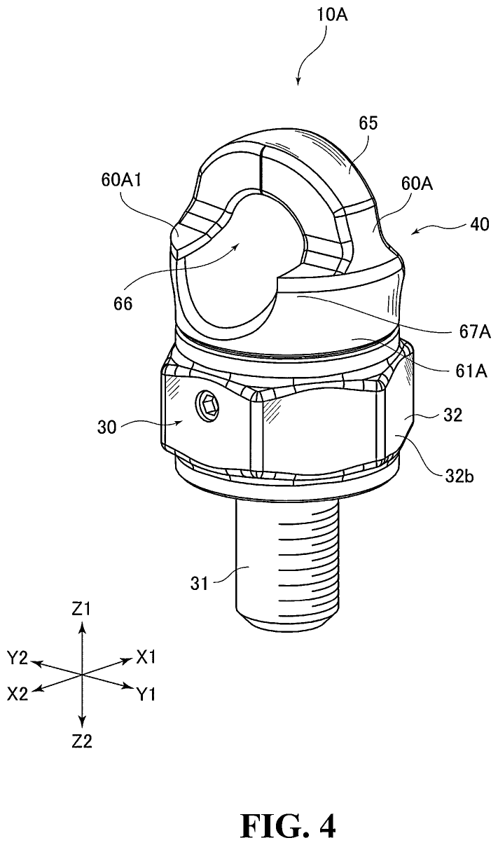

FIG. 4 is a side view illustrating a configuration of a hanging fitting 10A having no slope part 63 as a comparison object. Note that regarding the hanging fitting 10A as the comparison object illustrated in FIG. 4, the same portions as those in the hanging fitting 10 will be explained using the same reference signs.

In the case where no slope part 63 exists as illustrated in FIG. 4, the main body part 60 is formed with an upper end surface 60A1 as in a main body part 60A in a rotary coupling member 40 of the hanging fitting 10A illustrated in FIG. 4. Therefore, in the configuration illustrated in FIG. 4, the slope part 63 in FIG. 1 is brought into a built-up state (in FIG. 4, a built-up portion is called a built-up part 67A). Therefore, when the link 80 turns, a corner portion, facing a coupling hole 66, of the built-up part 67A collides with the inner peripheral side of the link 80, and the collision is repeated to recess a collision portion, leading to a cause of damage to the link 80. Further, when the link 80 slightly moves along the center axis direction of the coupling hole 66, the built-up part 67A hinders the turn of the link 80 and limits the turning range to be narrow.

In contrast to the above, in this embodiment, the main body part 60 has such a configuration that the slope part 63 is provided and a portion corresponding to the built-up part 67A does not exist. This makes it possible to prevent the formation of the recess on the inner peripheral side of the link 80. Further, even if the link 80 slightly moves along the center axis direction of the coupling hole 66, its turn is not hindered by the built-up part 67A, so that a large turning range of the link 80 can be taken.

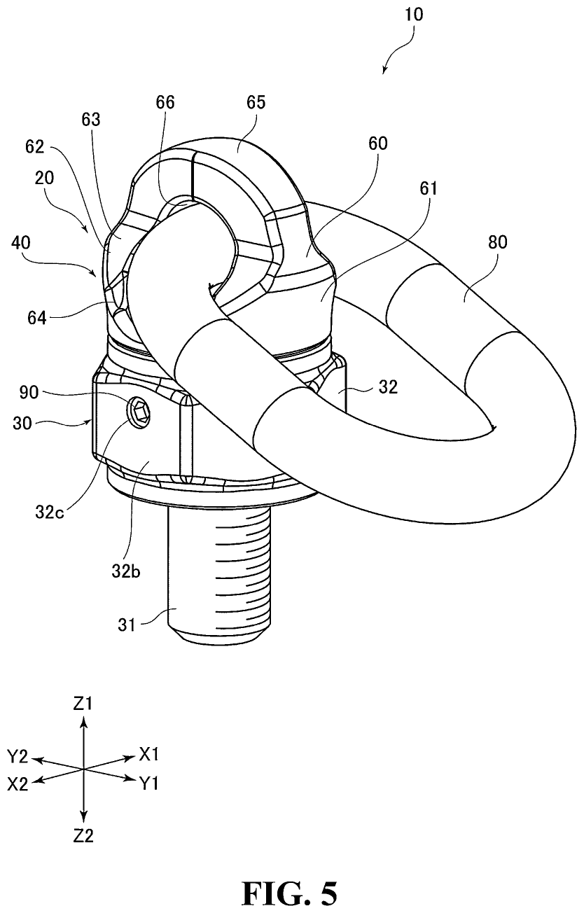

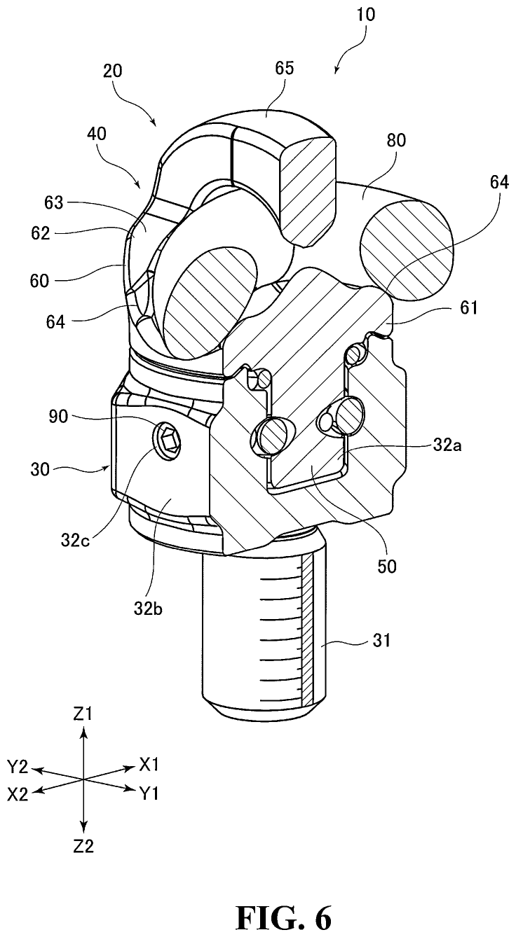

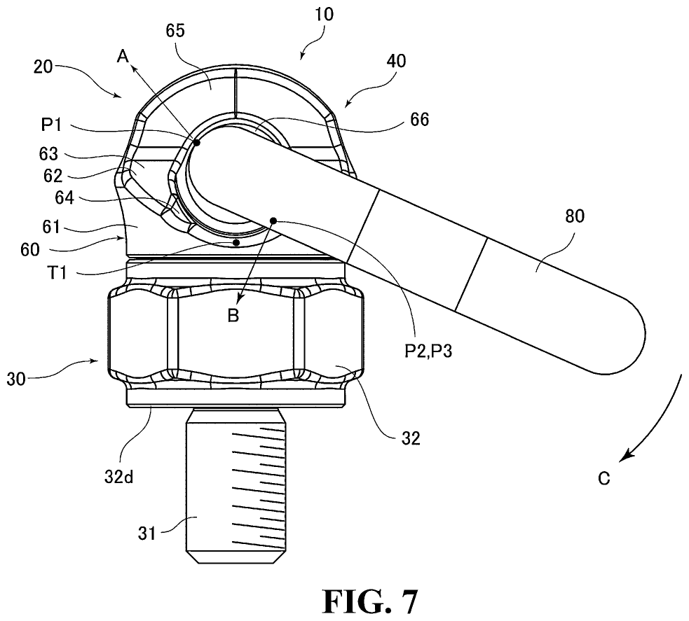

FIG. 5 is a perspective view illustrating a state where the link 80 is in contact with the link receiving part 64. FIG. 6 is a cross-sectional view illustrating a state where the hanging fitting 10 is cut along a plane (XZ-plane) passing through a contact portion between the link receiving part 64 and the link 80 in the state illustrated in FIG. 5. FIG. 7 is a side view illustrating the state where the link 80 is in contact with the link receiving part 64. As illustrated in FIG. 1 to FIG. 3 and FIG. 5 to FIG. 7, the link receiving part 64 is provided on the lower side (Z2 side) of the slope part 63. The link receiving part 64 is a portion which comes into contact with the link 80 when the link 80 in a free state turns with an insertion portion into the coupling hole 66 as a fulcrum, to inhibit the link 80 from turning toward the male threaded part 31 side (lower side: Z2 side). The link receiving part 64 is provided at a position higher than a bottom part T1 of the coupling hole 66 to prevent the link 80 from colliding with the cargo.

Further, as is clear from FIG. 6, a distance (radius) from the center in a radial direction of the main body part 60 to the link receiving part 64 is provided smaller than a distance (radius) from the center in the radial direction of the main body part 60 to an outer peripheral surface of the base part 61. Further, as is clear from FIG. 4 and FIG. 5, with the link receiving part 64, not a bar-shaped portion along the straight line of the link 80 but a curved portion along an arc comes into contact. Therefore, the rotary coupling member 40 can be reduced in diameter as compared with the case where the link receiving part 64 comes into contact with the bar-shaped portion of the link 80.

Further, in this embodiment, the link receiving part 64 is provided in a concave curved surface shape unlike a planar-shaped inclined surface 63a. In other words, the link receiving part 64 is a form made by cutting the inclined surface 63a of the slope part 63 into a concave curved surface shape. This makes the link 80 easily enter the link receiving part 64.

Besides, the coupling hole 66 is a hole portion into which the link 80 is inserted. The coupling hole 66 is surrounded by the base part 61 and the beam part 65, and is provided so that its inside diameter at the middle portion in the width direction (X-direction; corresponding to the crossing direction) of the base part 61 and the beam part 65 becomes smallest. Further, the coupling hole 66 is formed to increase in inside diameter as it separates from the middle portion. This forms such a configuration that the link 80 easily turns with a portion having the smallest inside diameter of the coupling hole 66 as a fulcrum. Note that the axial direction of the coupling hole 66 is the X-direction and the X-direction corresponds to the crossing direction, but the axial direction of the coupling hole 66 may be a direction crossing the Z-direction and different from the X-direction. Note that this direction also corresponds to the crossing direction.

Note that in this embodiment, the inside diameter of the coupling hole 66 is provided to have a size of 1.1 to 1.5 times the diameter of the cross section of the link 80. Thus, when the link 80 turns, it is possible to inhibit the link 80 from turning toward the cargo by the contact of the link 80 with the link receiving part 64, while suppressing the movement of the link 80 inside the coupling hole 66.

Further, the bottom part T1 of the coupling hole 66 is a portion at the lowest position of the coupling hole 66. However, the position of the bottom part T1 does not need to be the lowest position of the coupling hole 66. In other words, as explained above, the coupling hole 66 is provided so that the inside diameter at the middle portion in the center portion in its axial direction (X-direction) is smallest. Therefore, the bottom part T1 only needs to exist on the line of a projection line obtained by projecting the center axis of the coupling hole 66 below the coupling hole 66. In this case, when the main body part 60 is cut along the XY-plane, the position on the projection line on the cross section is the lowest position.

Note that as is clear from FIG. 1 and so on, near both ends in the width direction (X-direction) of the rotary coupling member 40, the beam part 65 does not exist on the upper portion side (Z1 side) and therefore recessed portions are provided at the rotary coupling member 40. However, in this embodiment, the recessed portions are also called the coupling hole 66.

### <Regarding the Slope Part 63, the Link Receiving Part 64, and the Coupling Hole 66>

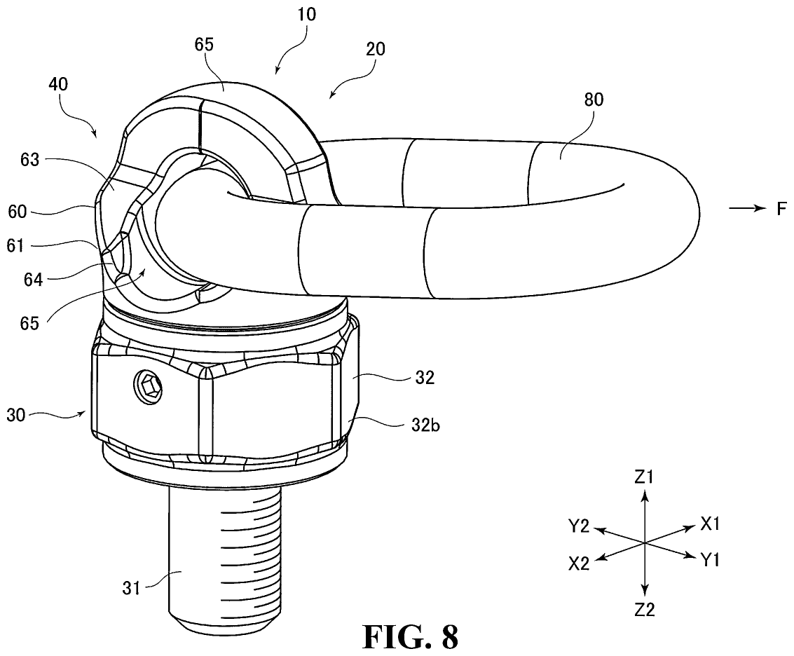

The above slope part 63, link receiving part 64, and coupling hole 66 will be explained in detail below. The slope part 63 is a portion which guides, when the link 80 comes into contact therewith, the link 80 toward the link receiving part 64. For example, when the link 80 moves toward the cargo (male threaded part 31) due to the vibration or the like of the link 80, the link 80 collides with the slope part 63. FIG. 8 illustrates an example of that state. In the collision state as illustrated in FIG. 8, any portion of the link 80 comes into contact with any portion of the slope part 63.

Here, when the longitudinal direction of the link 80 is pulled in an orientation (arrow F direction in FIG. 8) inclined with respect to the Y-direction as illustrated in FIG. 8, the link 80 keeps the contact state with any portion of an inner peripheral edge portion of the coupling hole 66 of the slope part 63. In this event, the link 80 interferes with the inner peripheral edge portion of the slope part 63, and therefore becomes a state of not moving any longer to the lower side (Z2 side). Accordingly, the tip end side (side away from the coupling hole 66 in the longitudinal direction of the link 80) of the link 80 becomes a state of being located on the upper side (Z1 side) than that illustrated in FIG. 5 and FIG. 7.

On the other hand, in a free state where a force of pulling from an external part does not act on the link 80, the link 80 lowers along the inner peripheral edge portion of the slope part 63 and the link 80 comes into contact with the link receiving part 64, whereby the lowering o the link 80 stops. In this event, the link 80 comes into contact with three points such as a contact position P1 at the middle portion in the width direction (X-direction) of the coupling hole 66, a contact position P2 of the link receiving part 64 located closer to one side (X1 side) in the width direction (X-direction) than the beam part 65, and a contact position P3 of the link receiving part 64 located closer to the other side (X2 side) in the width direction (X-direction) than the beam part 65. A state of this state viewed from the side surface is FIG. 7.

Note that a portion on the lowest side (Z2 side) of the link 80 is located on the upper side (Z1 side) than a bottom surface 32d on the lowest side (Z2 side) of the fitting coupling part 32 in the state illustrated in FIG. 7.

The contact positions P1 to P3 are not on one straight line, but are in a state of drawing a triangle having a predetermined size when linking the contact positions P1 to P3. Further, as illustrated in FIG. 7, the contact position P1 is located on the upper side (Z1 side) than the contact positions P2, P3. Further, the contact positions P2, P3 are provided at positions higher than the bottom part T1. In this state, the link 80 cannot move any more if trying to move in an arrow A direction at the contact position P1 in FIG. 7. Besides, the link 80 cannot move any more if trying to move in an arrow B direction at the contact positions P2, P3 in FIG. 7.

Accordingly, due to the restriction of the movement, the link 80 is inhibited from moving any more if trying to turn in an arrow C direction illustrated in FIG. 7 with the contact position P1 as a fulcrum of rotation because the link 80 interferes with the link receiving part 64 at the contact positions P2, P3.

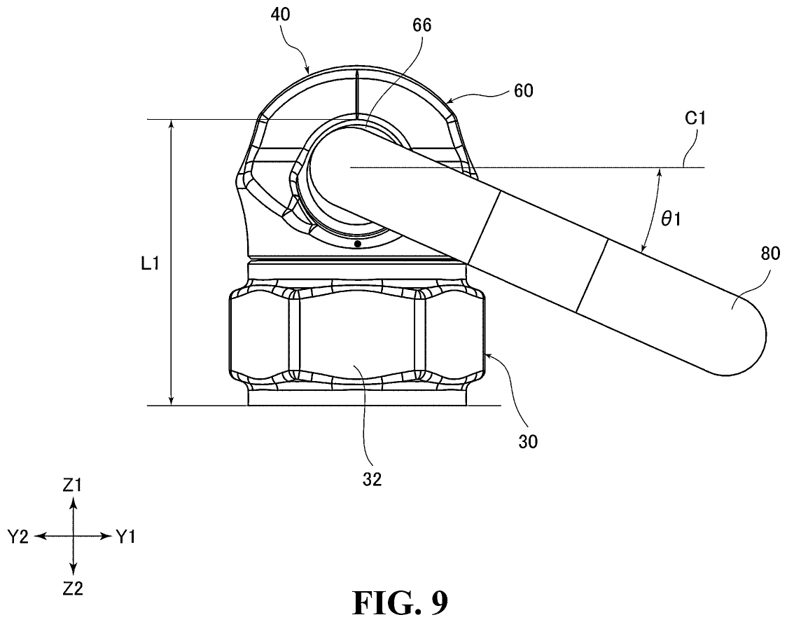

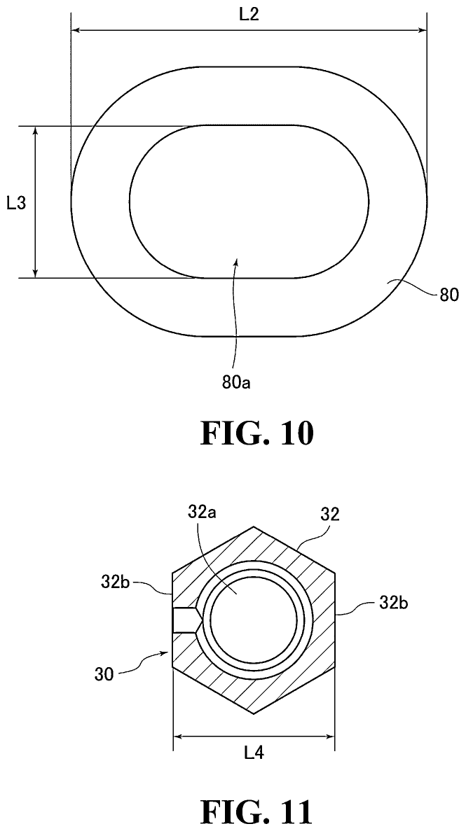

Here, the dimensional relationship among principal portions of the anchor fitting 30, the rotary coupling member 40, and the link 80 will be explained below. First, as illustrated in FIG. 9, a dimension from the lower end portion (end portion on the Z2 side) of the fitting coupling part 32 of the anchor fitting 30 to the upper end portion (end portion on the Z1 side) of the coupling hole 66 is assumed to be a dimension L1. Further, as illustrated in FIG. 10, a dimension in the longitudinal direction of the link 80 is assumed to be a dimension L2, and a width dimension of an inner hole 80a of the link 80 is assumed to be a dimension L3. Further, as illustrated in FIG. 11, a dimension between facing outer peripheral parts 32b in a plane shape in plan view of the fitting coupling part 32 or in a cross-sectional shape when cutting the fitting coupling part 32 at the XY-plane is assumed to be a dimension L4. Further, as illustrated in FIG. 9, an inclination angle of the link 80 in a state of being in contact with the contact position P1 of the coupling hole 66 and with the contact positions P2, P3 of the link receiving part 64, with respect to a line C1 passing through the center of the coupling hole 66 and being parallel to the lower end portion of the fitting coupling part 32 is assumed to be an inclination angle θ1.

In this case, to facilitate the production of the hanging fitting 10, it is preferable that the following relationship exists among the dimensions L1 to L4 and the inclination angle θ1. However, it is necessary to set the dimensions L1 to L4 and the inclination angle θ1 with which the link 80 does not collide (come into contact) with the cargo.
L1:L2=1:1.4 to 2.1
L4:L3=1:0.5 to 1.1
20 degrees≤θ1≤35 degrees

Note that in the case where L1:L2=1:1.4 to 2.1 as above, it becomes possible to balance the length (dimension L2) in the longitudinal direction of the link 80 while suppressing the height (dimension L1) of the anchor fitting 30. It also becomes possible to achieve both the downsizing of the hanging fitting 10 and the easiness of slinging on the link 80. Further, when L4:L3=1:0.5 to 1.1, it becomes possible to achieve both the downsizing of the hanging fitting 10 and the easiness of slinging on the link 80. Further, when the inclination angle θ1 is set to 20 degrees≤θ1≤35 degrees, it becomes possible to reduce the projection of the link 80 not in use and improve the stability against the vibration or the like, and to balance the length (dimension L2) in the longitudinal direction of the link 80 while suppressing the height (dimension L1) of the anchor fitting 30.

### <Regarding Effects>

In the hanging fitting 10 having the above configuration, the rotary fitting 20 includes the anchor fitting 30 having the male threaded part 31 to be screwed into the threaded hole of the cargo, and the rotary coupling member 40 mounted on the anchor fitting 30 in a state of being rotatable around the rotation axis and being prevented from slipping out, the rotary coupling member 40 being provided with the main body part 60.

Further, the main body part 60 is integrally formed with the base part 61 around the rotation axis, the pair of raised parts 62 spaced apart in the circumferential direction of the base part 61, and the beam part 65 which continues to the raised parts 62 and surrounds, together with the pair of raised parts 62, the coupling hole 66 into which the link 80 is pivotally coupled, the pair of raised parts 62 being provided with the link receiving parts 64 each provided at a position further away from the anchor fitting 30 in the axial direction (Z-direction) of the rotation axis than the base part 61 and provided at the position where the link 80 comes into contact therewith in a state where the tip of the link 80 has a predetermined gap with respect to the cargo.

As explained above, when the tip end side of the link 80 turns toward the cargo, the link 80 comes into contact with the link receiving part 64 and thereby the link 80 is inhibited from turning toward the cargo any more. This makes it possible to prevent the link 80 from colliding (coming into contact) with the cargo.

Further, in this embodiment, the main body part 60 is provided with the base part 61, the pair of raised parts 62, and the beam part 65 which are integrally formed, and the pair of raised parts 62 are provided with the link receiving parts 64. Therefore, the number of parts can be reduced as compared with the configuration in which a separate link receiving part 64 is provided at the main body part 60, thus preventing an increase in man-hours when manufacturing the hanging fitting 10.

Further, in this embodiment, the slope parts 63 are provided continuing to the link receiving parts 64 on the sides, of the pair of raised parts 62, away from the male threaded part 31 in the axial direction (Z-direction) of the male threaded part 31, and the slope parts 63 have inclined surfaces 63a inclined with respect to the axial direction (Z-direction) of the male threaded part 31 and are across the base part 61 and the beam part 65.

In the case where the slope part 63 does not exist, the built-up part 67A as illustrated in FIG. 4 exists. In this case, when the link 80 turns, a portion of a corner, facing the coupling hole 66, of the built-up part 67A collides with the inner peripheral side of the link 80 to recess a collision portion, leading to a cause of damage to the link 80. Further, when the link 80 slightly moves along the center axis direction of the coupling hole 66, the built-up part 67A hinders the turn of the link 80 and limits the turning range to be narrow.

In contrast to the above, in this embodiment, the above slope part 63 is provided and a portion corresponding to the built-up part 67A does not exist, thus making it possible to prevent the formation of the recess on the inner peripheral side of the link 80. Further, even if the link 80 slightly moves along the center axis direction of the coupling hole 66, its turn is not hindered by the built-up part 67A, so that a large turning range of the link 80 can be taken.

Further, in this embodiment, the coupling hole 66 is provided to have a size of 1.1 to 1.5 times the diameter of the cross section of the link 80. Therefore, it is possible to prevent the link 80 from largely moving inside the coupling hole 66. Thus, when the link 80 turns, the link 80 comes into a state of being in contact with the contact position P1 in the coupling hole 66, whereby the link 80 comes into contact with the link receiving part 64 while the link 80 is prevented from moving any more in the arrow A direction in FIG. 7. Therefore, it becomes possible to inhibit the link 80 from turning toward the cargo.

Further, in this embodiment, the link receiving part 64 is provided in a concave curved surface shape. Therefore, as compared with the case where the corner portion around the coupling hole 66 cones into contact with the link 80, the link receiving part 64 can be brought into a state of coming into contact with the link 80 in a relatively large area. This can prevent damage to the link 80. Further, the link receiving part 64 is provided in a concave curved surface shape and thereby can be made into a state of further fitting with the outer surface shape of the link 80, thus making it possible to improve the performance to hold the link 80.

### Modification Examples

The embodiments of the present invention are explained above, and the present invention can be variously modified in addition to them. Hereinafter, the modifications will be explained.

In the above embodiments, the hanging fitting 10 includes the rotary fitting 20 and the link 80. However, the hanging fitting may be composed of only the rotary fitting 20.

Further, in the above embodiments, the main body part 60 of the rotary coupling member 40 is provided with the slope part 63. However, a configuration in which the link receiving part 64 is provided but the slope part 63 is not provided and is omitted may be employed.

Further, in place of the slope part 63 having the inclined surface 63a in the above embodiments, a portion in a step shape (step-shaped portion) having a plurality of step portions may be provided.

Further, the anchor fitting 30 in the above embodiments has the male threaded part 31 and is configured to be mounted on the mounting hole of the cargo being the hanging object. However, the male threaded part 31 is not necessary in the anchor fitting 30. For example, the anchor fitting may be mounted on the mounting surface of the cargo, for example, by a fastener such as a bolt being a separate member.

### REFERENCE SIGNS LIST

10, 10A . . . hanging fitting, 20 . . . rotary fitting, 30 . . . anchor fitting, 31 . . . male threaded part, 32 . . . fitting coupling part, 32a . . . coupling recessed part, 32b . . . outer peripheral part, 32c . . . input hole, 32d . . . bottom surface, 40 . . . rotary coupling member, 50 . . . rotary shaft part, 60, 60A . . . main body part, 61, 61A . . . base part, 61A1 . . . upper end surface, 62 . . . raised part, 63 . . . slope part, 63a . . . inclined surface, 64 . . . link receiving part, 65 . . . beam part, 66 . . . coupling hole, 67A . . . built-up part, 70 . . . bearing, 80 . . . link, 90 . . . hexagon socket head screw, P1 to P3 . . . contact position, T1 . . . bottom part

1. A hanging fitting to be mounted on a cargo and comprising a link and a rotary fitting coupled with the link,
the rotary fitting comprising an anchor fitting to be fixed to the cargo, and a rotary coupling member mounted on the anchor fitting in a state of being rotatable around a rotation axis and being prevented from slipping out,
the rotary coupling member being provided with a main body part,
the main body part being integrally formed with:
a base part around the rotation axis;
a pair of raised parts spaced apart in a circumferential direction of the base part; and
a beam part which continues to the raised parts and surrounds, together with the pair of raised parts, a coupling hole to which the link is pivotally coupled,
the pair of raised parts being provided with link receiving parts each provided at a position further away from the anchor fitting in an axial direction of the rotation axis than the base part and that contact the link and inhibit the rotation of the link so that a tip of the link has a predetermined gap with respect to the cargo.

2. The hanging fitting according to claim 1, wherein:
slope parts are provided continuing to the link receiving parts on sides, of the pair of raised parts, away from the anchor fitting in the axial direction; and
the slope parts have inclined surfaces inclined with respect to the axial direction and are across the base part and the beam part.

3. The hanging fitting according to claim 1, wherein
the coupling hole is provided to have a size of 1.1 to 1.5 times a diameter of a cross section of the link.

4. The hanging fitting according to claim 1, wherein
the link receiving part is provided in a concave curved surface shape.

5. The hanging fitting according to claim 2, wherein
the coupling hole is provided to have a size of 1.1 to 1.5 times a diameter of a cross section of the link.

6. The hanging fitting according to claim 2, wherein
the link receiving part is provided in a concave curved surface shape.

7. The hanging fitting according to claim 3, wherein
the link receiving part is provided in a concave curved surface shape.

8. The hanging fitting according to claim 5, wherein
the link receiving part is provided in a concave curved surface shape.
